(19) United States
(12) Patent Application Publication
(10) Pub. No.: US 2005/0196501 A1
(43) Pub. Date: Sep. 8, 2005

(54) Cooking method and apparatus

(76) Inventors: Mark Black, Helenvsvale (AU); Marton Rajnai, Helensvale (AU)

Correspondence Address: Martin P Hoffman;Hoffman Wasson & Gitler, Suite 522, 2361 Jefferson Davis Highway, Arlington, VA, 22202, US

(21) Appl. No.: 10/515,333

(22) PCT Filed: Jun. 12, 2003
(86) PCT No.: PCT/AU03/00727

§ 371 Date: Dec. 2, 2004

(30) Foreign Application Priority Data
Jun. 12, 2002 (AU) PS 2890

(51) Int. Cl. A23L 1/216

(52) U.S. Cl. 426/509

(57) ABSTRACT

An apparatus and method are disclosed for cooking a foodstuff whereby the foodstuff is placed in the body of the apparatus which is then immersed in boiling water until the foodstuff is cooked. The apparatus includes an elongated tubular body having at opposite ends removable caps. The body and caps are adapted such that the cooked foodstuff adopts a shape defined by the internal surfaces of the body and caps. An optional feature is the inclusion of a solid tube which is of the same length as the body and is held concentrically within the body by the end caps. This creates a hollow core within the cooked foodstuff in which can be placed second victuals. The cross-sectional shape of the body and tube is determined by the required cross-sectional configuration of the cooked foodstuff and includes circular, square, rectangular, triangular, star-shaped, letters, numerals and symbols. Other optional features include fins fixed to the apparatus to assist its rotation as the foodstuff is being cooked, and various means for supporting the apparatus in use dependent on whether the apparatus is used in a domestic or commercial environment.

### TECHNICAL FIELD

This invention relates to a method and apparatus for cooking foodstuff.

### BACKGROUND ART

Many different methods and apparatii are currently used for cooking foodstuff. For example, to cook an egg by boiling, an egg is commonly placed in its shelf into a container of boiling water. After a certain period of time depending upon the extent that the egg is required to be cooked to produce either a “hard” or “soft” egg, the egg is taken out of the container and presented for eating or allowed to cool. The shell is then removed from the egg to allow access to the egg white and egg yoke therein. In many instances, the shell is removed from the egg to present the whole egg. This, for example, is often undertaken in restaurants and other food establishments. Removing the shell from an egg, however, as well as being time consuming, often is difficult where it is necessary to present the egg in a whole unblemished form. Commonly, parts of the egg remain with the shell or the egg may be otherwise damaged. This results in wastage of egg and, in addition, deterioration in the appearance of the shelled egg which renders them unsuitable for presentation.

As another example, rice or pasta is often cooked by placing in boiling water for a period sufficient to soften the food to an edible consistency, after which the cooked food is strained from the boiling water and then placed and presented on a serving plate. In a busy restaurant, this preparation and presentation time can be significant. Further, as the cooked food is essentially free from any containment once strained from the boiling water, there are only limited options available to the chef for the food to be presented attractively to the diner.

### SUMMARY OF THE INVENTION

The present invention aims to provide an improved method and apparatus for cooking foodstuff which overcomes, or at least alleviates, one or more of the above disadvantages or at least provides an alternative to the known methods and apparatii for cooking foodstuff. Other objects and advantages of the invention will become apparent from the following description.

The present invention thus provides, in a first aspect, a method of cooking foodstuff, said method including the steps of:
providing a container means, said container means including a hollow body and at least one removable closure means for said hollow body, said container means being adapted to be placed into boiling water or water to be boiled, said water providing a source of heat
placing said foodstuff into said container means such that said foodstuff, when coked, adopts a shape substantially defined by the internal surfaces of said container means;
closing said container means;
exposing said container means to said source of heat for a period of time sufficient to cook said foodstuff in said container means; and
removing thus cooked said foodstuff from said container means.

Preferably, said container means includes a hollow elongated body and said at least one removable closure means is at one end thereof and said method thus includes the step of removing said closure means to allow the placement of said foodstuff into said elongated body and thereafter re-attaching said closure means to said elongated body prior to exposing said container means to said source of heat. Said closure means suitably substantially seals said elongated body when engaged therewith to prevent escape of said foodstuff therefrom and/or to prevent water entering said elongated body.

More preferably, said container means includes a pair of said closure means each adapted to be removably engaged with opposite ends of said elongated body.

In use, preferably, for receiving said foodstuff, one of said closure means is detached from said elongated body and, for removal of cooked foodstuff, both said closure means are suitably detached from said elongated body to enable the cooked foodstuff to be removed longitudinally in one length from said elongated body.

In an embodiment of the present invention, said elongated body further includes a substantially tubular body, removably held, preferably concentrically, within said elongated body. In this embodiment, the present invention provides a method of cooking a foodstuff with a hollow core to which can be added second victuals, which usually differ from said foodstuff.

In another embodiment of the present invention, said method further includes the step of rotating said container means about its longitudinal axis during exposure to said source of heat, thus assisting in the even cooking of said foodstuff within said container means. In this embodiment, and when said foodstuff is an egg(s), said step of rotating said container means causes the egg white to locate radially outwardly of the egg yolk, the latter locating centrally within said container means.

If desired, suitable additives may be incorporated into said foodstuff prior to cooking. Said additives may include, for example, a food colouring.

In a second aspect of the present invention, there is provided an apparatus for use in a method of cooking foodstuff as hereinbefore described, said apparatus including:
a container means, said container means having a hollow body adapted to hold sufficient said foodstuff such that said foodstuff, when cooked, adopts a shape substantially defined by the internal surfaces of said container means; and
at least one closure means at one end of said hollow body for closing said hollow body, said closure means being removable to permit said foodstuff to be placed in said hollow body prior to cooking and removed from said hollow body after said foodstuff has been cooked;
wherein said container means is adapted to be placed into boiling water or water to be boiled, said water providing a source of heat to cook said foodstuff therein.

Preferably, said hollow body is a hollow elongated body.

Preferably, said container means includes a pair of said closure means adapted to be removably engaged with, and at opposite ends of, said elongated body. Said closure means when engaged with said elongated body preferably substantially seals said elongated body to prevent escape of said foodstuff therefrom or to prevent water entering said elongated body.

The cross-section of said elongated body may be of any shape as determined by the desired cross-sectional configuration to be produced in said foodstuff once cooked. For example, said elongated body may be of circular cross-section and thus of cylindrical form. Alternatively, said elongated body may be of a cross-sectional form such as square, rectangular, triangular, star shaped, letters, numerals or symbols.

In an embodiment of the present invention, said elongated body further includes a substantially tubular body, removably held, preferably concentrically, within said elongated body. Once again, the cross-section of said tubular body may be of any shape determined by the cross-sectional configuration desired for the resultant hollow core in the cooked foodstuff to which a second victuals is to be added.

In an embodiment of the apparatus of the present invention, said apparatus comprises a single hollow body having removable closure means at each end, said closure means at one end preferably being mounted to or formed with a base to enable said hollow body to be supported in an upright attitude by said base seating on a supporting surface during the cooking process. The base may be of any configuration to stably support said container means in a generally upright attitude during cooking; for example, said base can be of plate-like configuration and include a plurality of supporting legs. The source of heat for cooking said foodstuff usually comprises boiling water in a cooking utensil such as a pot and said base of said apparatus seats, in use, on said base of said cooking utensil for the purposes of cooking said foodstuff Apparatus of this embodiment is particularly, but not exclusively, suited to use in domestic situations.

In another embodiment of the apparatus of the present invention said apparatus comprises one or more of said container means each said container means being connectable to, so as to extend from, a support member. In this embodiment, said apparatus may be located over a cooking utensil containing boiling water or water to be boiled such that each said container means is supported by said support member which spans said utensil, said container means extending generally vertically downwardly from said support member to be submerged in water whereby foodstuff in said container means is cooked when said water is boiled. Further, in this embodiment, one of said closure means of said container means is attached to or is incorporated into the underside of said support member.

Preferably, in this embodiment, said support member supports a plurality of said container means for receiving and cooking a plurality of said foodstuff Apparatus of this embodiment is particularly, but not exclusively, suitable for use in commercial situations.

Preferably, said support member includes one or more handles to facilitate manipulation of said apparatus. Said support member may be of a lid-like configuration so as to sit on said cooking utensil in use; however, it may be of any suitable alternative configuration.

In yet another embodiment of the apparatus of the present invention, said apparatus includes means for supporting said container means for rotation about its longitudinal axis such that said container means may be rotated about said axis when said container means is subject to a source of heat to cook said foodstuff therein. By rotation of said container means, when said foodstuff is an egg, the egg yolk locates centrally in said container means and the egg white will locate radially outwardly of the egg white and the egg therein will be cooked evenly.

In this embodiment, any suitable means may be provided for rotating said container means. For example, said container means can include one or more vanes or fins on its periphery, said vanes or fins being exposed to said boiling water so as to cause said container means to rotate.

Preferably, each said container means is supported by a support frame on a baffle-like member which is configured to trap boiling water and direct said boiling water towards said fins on said container means. For this purpose said baffle-like member can include a plurality of apertures for directing said water towards said fins.

### BRIEF DESCRIPTION OF THE DRAWINGS

In order that the invention may be more readily understood and put into practical effect, reference will now be made to the accompanying drawings which illustrate preferred embodiments of the invention and wherein:

FIG. 1 is an exploded perspective view of a first form of a cooking apparatus according to an embodiment of the invention;

FIG. 2 is an exploded perspective view of a second form of a cooking apparatus according to an embodiment of the invention;

FIG. 3 is a longitudinal sectional view of a tube for containing a foodstuff for cooking as attached to the lid or base plate of the apparatus of FIGS. 1 or 2;

FIG. 4 is a cross sectional view of the cooking tube along line A-A of FIG. 3;

FIG. 5 is an enlarged underside view of the lid for the cooking apparatus of FIG. 2;

FIG. 6 is a sectional view along lines B-B of FIG. 5;

FIGS. 7 and 8 illustrate in side and end elevation a third form of cooking apparatus according to an embodiment of the invention;

FIGS. 9 and 10 illustrate in side elevation and underside view, a base assembly for the cooking apparatus of the type shown in FIGS. 7 and 8;

FIG. 11 is a plan view of the base plate of the base assembly of FIGS. 9 and 10;

FIG. 12 is a partially exploded perspective view of an alternative configuration of certain components common to the apparatii of FIGS. 1 to 11; and

FIG. 13 is a perspective view of a fourth form of cooking apparatus according to an embodiment of the invention.

### DETAILED DESCRIPTION OF THE EMBODIMENTS

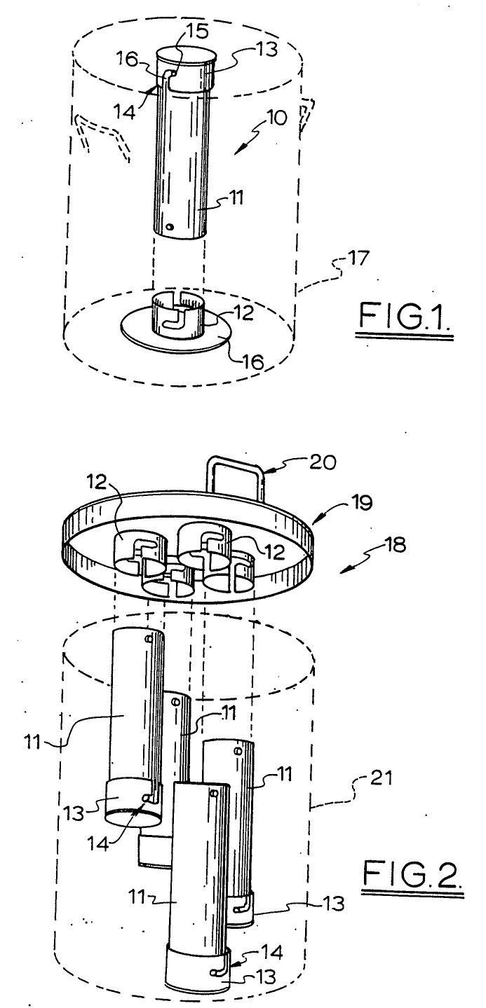

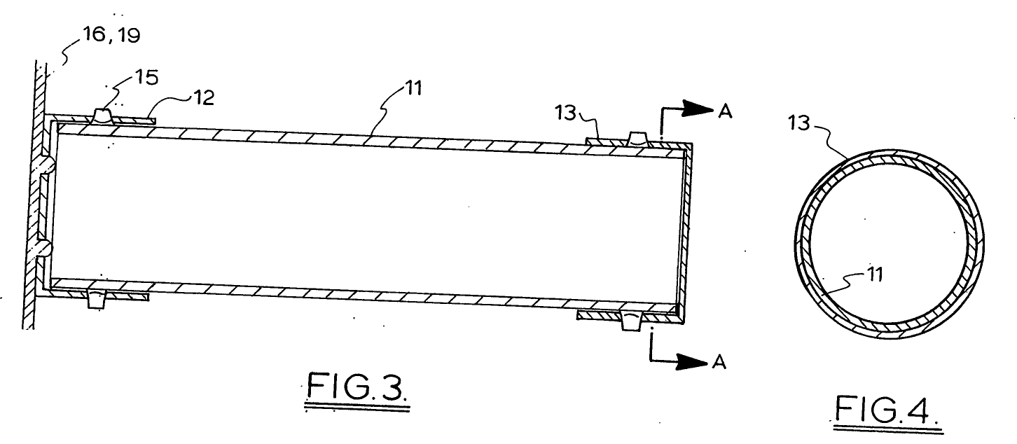

Referring to the drawings and firstly to FIG. 1, there is illustrated a first form of cooking apparatus 10 suitable for cooking eggs, according to an embodiment of the present invention including a tubular member 11 of generally cylindrical form and having at opposite ends removable cup-shaped caps 12 and 13 of substantially the same internal diameter as the external diameter of the tubular member 11. The caps 12 and 13 are preferably engaged with the ends of the tubular member 11 by means of a quick release bayonet type connection 14, the ends of the member 11 for this purpose being provided with opposite ears 15 for location in opposite L-shaped slots 16 in the caps 12 and 13 (see also FIG. 3). The caps 12 and 13 when engaged with the ends of the tubular member 11 substantially seal the tubular member 11 to prevent water passing into the member 11 and egg escaping from the member 11. In the embodiment of FIG. 1, one of the caps 12 is fixed to a base plate 16 for example by welding. Alternatively, the cap 12 may be formed integrally with the base plate 16 in which case the end of the cap 12 may be defined by the base plate 16.

In use and for cooking eggs, an utensil such as a pot 17 (shown in dotted outline) is initially filled with water and the pot 17 exposed to a suitable heat source such as by being placed on a hot plate or flame so that the water in the pot 17 is brought to the boil. One of the caps 12 or 13 is removed and one or more eggs are cracked and broken into or otherwise supplied to the tubular member 11 Preferably, however, the tubular member 11 is filled or substantially filled with egg yolk and white from a plurality of eggs. Preferably, the internal surface of the tubular member 11 is coated lightly with oil or other non-stick material prior to depositing the eggs therein. Alternatively, the inner surface of the tubular member 11 may be provided with a non-stick surface such as Teflon.

After the egg whites and yolks are deposited into tubular member 11 the removed cap 12 or 13 is replaced to seal the tubular member 11. The apparatus 10 is then placed into the pot 17 with the base 16 lowermost and seating on the base of the pot 17 to support the tubular member 11 in an upright attitude. The water in the pot 17 is then maintained boiling for a period of time sufficient to cook the egg or eggs within the tubular member 11 Usually, this period is 15 to 20 minutes. Thereafter, the apparatus 10 is removed from the pot 17 and placed in cold water or otherwise cooled to cool the member 11 and the cooked egg therein. After a sufficient cooling period the caps 12 and 13 are removed and the cooked eggs pushed longitudinally out of the member 11, preferably with the use of a plunger. The cooked egg is in sausage-like form with the white of the egg on the outside surrounding the yoke on the inside. The cooked egg may then be cut transversely as required for serving. Apparatus of the type shown in FIG. 1 is particularly suited for use in domestic situations.

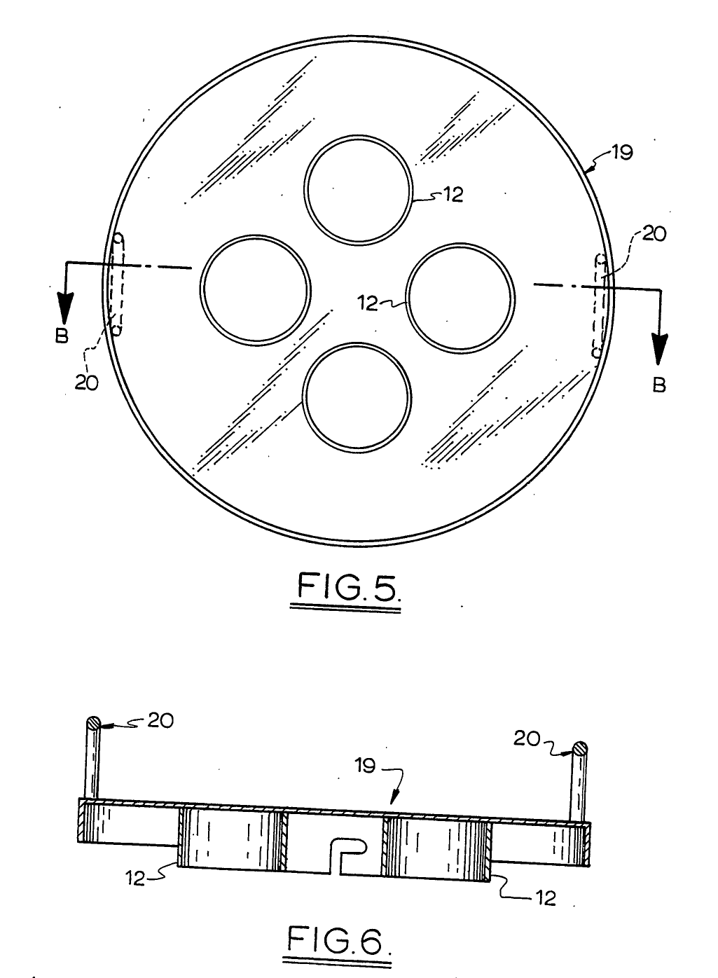

FIGS. 2 to 5 illustrates a further embodiment of cooking apparatus 18 according to the invention which is similar in principle to the embodiment of FIG. 1 and in which like components to that of FIG. 1 have been given like numerals. In this case, the apparatus 18 includes a plurality of elongated tubular members 11, in this case four, adapted to be closed at one end by removable caps 12 and at their other ends by caps 13. As in the embodiment of FIG. 1, the caps 12 and 13 are connectable to opposite ends of the members 11 by bayonet-type connections 14. The elongated tubular members 11 in this embodiment are adapted to be supported from a rimmed lid 19 with the caps 12 being secured, for example by welding to the underside of the lid 19. Alternatively, the lid 19 may be formed with the caps 12 integral. The lid 19 also includes a pair of U-shaped handles 20 which are arranged diametrically on opposite sides of the top of the lid 19.

As in the embodiment of FIG. 2, either caps 12 or 13 may be detached from each body 11 with the other caps 13 or 12 remaining attached. Alternatively, the tubular members 11 may be detached from the caps 12 on the lid 19. A plurality of eggs are then cracked and broken into the respective tubular members 11. After the tubular members 11 have been filled, the removed caps 12 or 13 are replaced (or the tubular members 11 re-engaged with the caps 12 on the underside of the lid 19). The apparatus 18 is then positioned over a utensil 21 of boiling water or water to be boiled and the tubular members 11 lowered into the water until the lid 19 sits on the upper edge of the utensil 21 with the tubular members 11 fully submerged. The lid 19 may substantially close the utensil 21 in this position. Again the tubular members 11 are left within the boiling water a sufficient period of time to cook the eggs therein, usually 10 to 15 minutes, and thereafter the apparatus 18 is removed and cooled, the caps 12 and 13 detached from each end of the tubular members 11 and the cooked eggs therein removed again with the assistance of a plunger, if required, ready for serving as described above. Apparatus of the type shown in FIG. 2 is particularly suited for use in commercial situations.

Referring now to FIGS. 7 to 11, there is illustrated a further embodiment of a cooking apparatus 22, suitable for cooking eggs, and components thereof according to the present invention. The apparatus 22 includes, as before hollow tubular members 23 which are closed by removable cup-shaped end caps 24, the caps 24 being connectable to the tubular members 23 b [symbol] bayonet type connections 25. The end caps 24 in this case are provided with central outwardly extending spigots 26 which are aligned with the longitudinal axis of the members 23 and which serve as supporting axles for the tubular members 23. The wall of each tubular member 23 is provided around its periphery with a series of fins 27 which extend generally longitudinally of the member 23 but angled to the longitudinal axis of the member 23.

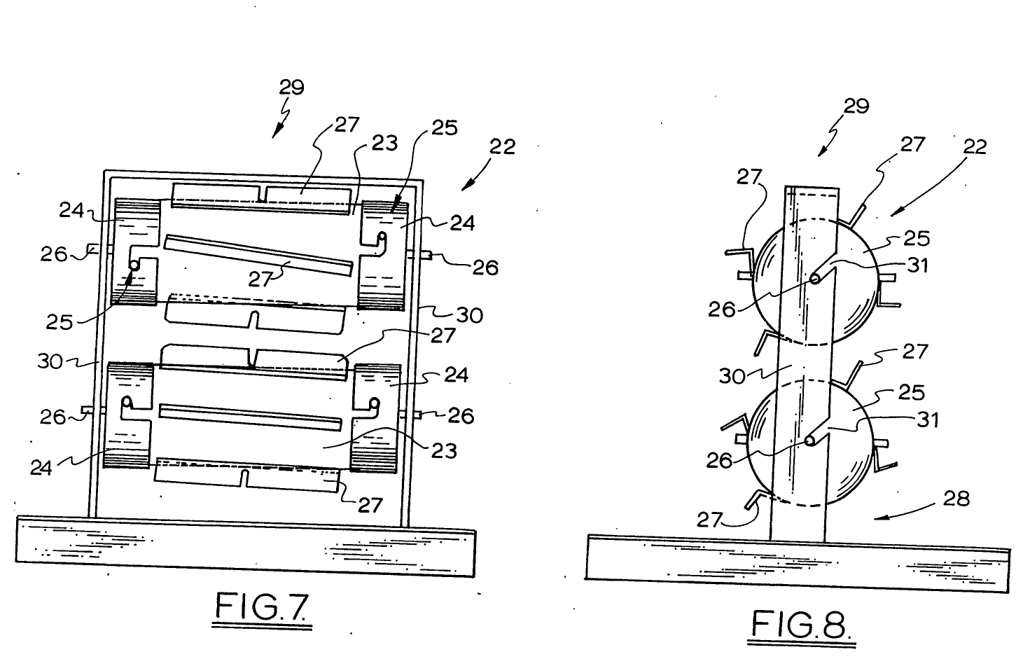

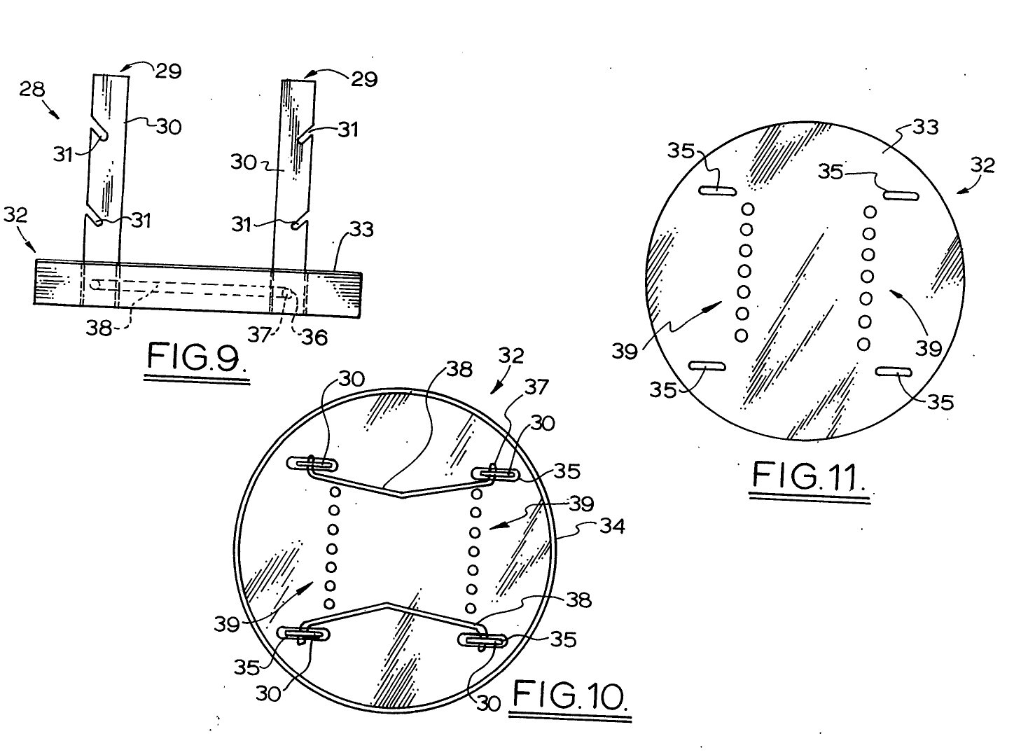

The respective tubular members 23 are supported in a horizontal attitude, one above the other by a base assembly 28 which includes upright U-shaped members 29 (only one of which is shown in FIGS. 7 and 8) each having a pair of side arms 30. The side arms 30 are provided with aligned downwardly angled slots 31 sized to accept the spigot ends 26 of the caps 24. The U-shaped members 29 are supported on, and extend upwardly from, a hollow baffle-like base 32 having a top wall 33 and a downwardly extending flange 34 around the periphery thereof. The top wall 33 of the base 32 is provided with spaced slots 35 to receive opposite free ends of the arms 30. The a [symbol] 30 are provided with holes 36 adjacent their free ends to accept the ends 37 of retaining pins 38 to retain the U-shaped members 29 to the base 32. A series of apertures 39 in two rows are provided in the top wall 33 of the base 32 between the slots 35. The apertures 39 are substantially vertically aligned in use with the fins 27 on the tubular members 23. The base assembly 28 as shown in FIGS. 9 to 11 is designed to support four tubular cooking members 23, the supporting spigots 26 therefor locating in the respective slots 31 in opposite arms 30 of the members 29.

In use, the tubular members 23 are detached and one cap 24 thereof removed. Eggs, as before, are then cracked and broken into or otherwise supplied to the tubular members 23 through the open end. After the tubular members 23 have been filled or substantially filled with egg, the removed cap 24 is re-engaged with the tubular member 23 to seal the raw egg therein. The tubular members 23 with caps 24 engaged at each end are then supported on the base assembly 28 with the spigots 26 of opposite caps 24 located within the slots 31 where they are held by the weight of the filled members 26. The apparatus 22 is then supported in a container of boiling water. Water boiling which is trapped beneath the base 32 is forced through the openings 39 to act upon the fins 27 to cause the members 23 to rotate about their longitudinal axis on the spigots 26. This will ensure even cooking of the egg within the members 26 and help maintain the egg yoke in the middle of the tubular members 23 and the white on the outside of the yolk. After a period of time sufficient to cook the eggs to the desired hardness, the apparatus 22 is removed from the boiling water and the tubular members 23 detached and cooled. As before, when the tubular members 23 are sufficiently cooled, the end caps 24 at each end are removed and the cooked eggs pushed longitudinally out of the members 23 in form of one continuous egg having the cross sectional shape of the tubular member 23. The cooked egg may then be severed transversely as desired and served.

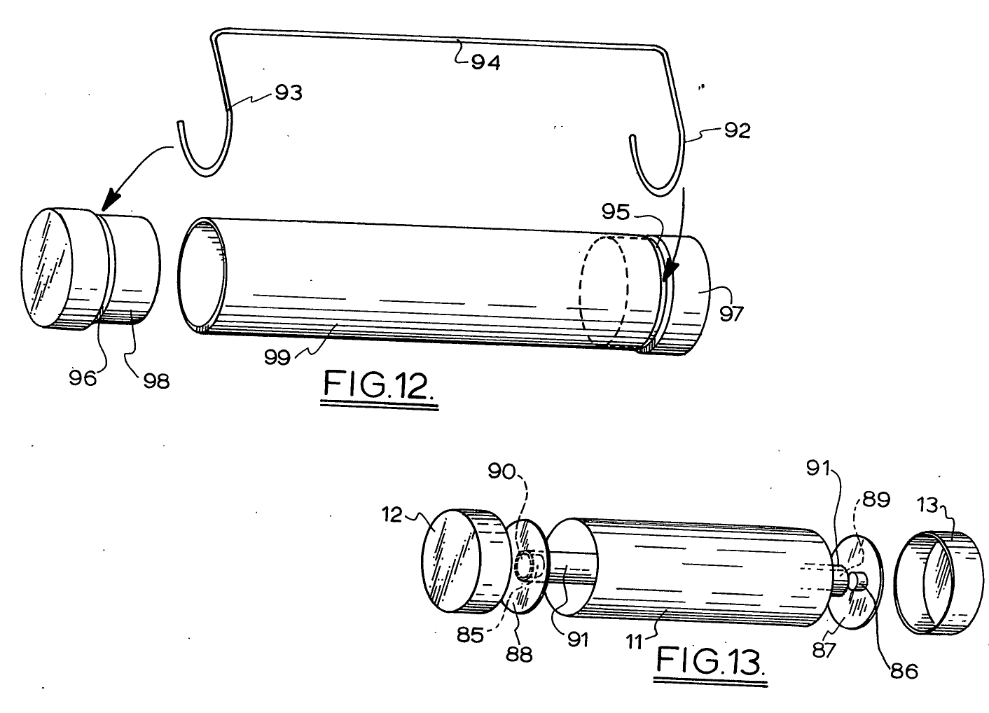

With reference to FIG. 12, which illustrates certain components common to the cooking apparatii described above with reference to FIGS. 1 to 11, a tubular member 99 of generally cylindrical form and having at opposite ends removable cup-shaped caps 98 and 97 of substantially the same internal diameter as the external diameter of the tubular member 99, function essentially identically to the corresponding tubular members 11 and 23 and end caps 12, 13 and 24 described above with reference to FIGS. 1 to 11. However, the manner in which the caps 98 and 97 are engaged with the ends of the tubular member 99 differs in that each end cap 98 and 97 includes a respective circumferential groove 96 and 95. When the caps 98 and 97 are engaged with the ends of the tubular member 99 the grooves 96 and 95 remain exposed to allow a shaped resilient wire clip 94, having shaped ends 93 and 92, each end 93 and 92 capable of sitting in the respective groove 96 or 95, to be positioned and resiliently retained in the grooves 96 and 95.

FIG. 13 illustrates a further embodiment of a cooking apparatus according to the invention which is similar in principle to the embodiment of FIG. 1 and in which like components to that of FIG. 1 have been given like numerals. The caps 12 and 13 are detachable from the tubular member 11 as before. However, a solid tube 91, of substantially identical length to that of the tubular member 11 and having short bores 90 and 89 in the respective ends thereof, can be positioned within the tubular member 11. The tube 91 is held within the member 11 by a pair of removable discs 88 and 87. Each disc 88 and 87 has a short spigot 86 and 85 extending from the centre thereof and adapted to engage the respective bores 90 and 89, and each disc 88 and 87 is of a diameter substantially the same as the internal diameter of the respective end caps 12 and 13. When assembled, the discs 88 and 87 are held within the respective end caps 12 and 13 which, in turn, retain the tube 91 substantially concentrically within the member 11.

In use, this embodiment allows foodstuff to be cooked as before and to be removed from the member 11. However, a hollow core will be present in the cooked foodstuff in which can be placed second victuals,

Typically, the components of the cooking apparatus as described in all of the above embodiments are constructed of cooking grade aluminium or stainless steel. However, any other suitable metal can be used. Similarly, the fins 27 on the tubular members 23, whilst shown in the drawings to be of angle sectioned form, may be of any shape and configuration which will effect rotation of the members 23 when impinged upon by boiling water.

The present invention thus provides a method and apparatus in which foodstuff can be cooked effectively and efficiently for presentation in a cooked form in many different shapes and, if required, can also include second victuals within the cooked foodstuff which thus expands upon the presentation possibilities for a chef.

Whilst the above has been given by way of illustrative embodiments of the present invention, all such modification and variations thereto as would be apparent to persons skilled in the art are deemed to fall within the broad scope and ambit of the invention as defined in the following claims free from any containment once strained from the boiling water, there are only limited options available to the chef for the food to be presented attractively to the diner.

### SUMMARY OF THE INVENTION

The present invention aims to provide an improved method and apparatus for cooking foodstuff which overcomes, or at least alleviates, one or more of the above disadvantages or at least provides an alternative to the known methods and apparatii for cooking foodstuff. Other objects and advantages of the invention will become apparent from the following description.

The present invention thus provides, in a first aspect, a method of cooking foodstuff, said method including the steps of:
providing a container means;
placing said foodstuff into said container means;
closing said container means;
exposing said container means to a source of heat for a period of time sufficient to cook said foodstuff in said container means; and
removing thus cooked said foodstuff from said container means.

Preferably, said container means is placed into boiling water or water to be boiled, the boiling water comprising the source of heat for cooking said foodstuff.

Preferably, said container means includes a hollow elongated body and at least one removable closure means at one end thereof and said method thus includes the step of removing said closure means to allow the placement of said foodstuff into said elongated body and thereafter re-attaching said closure means to said elongated body prior to exposing said container means to a source of heat. Said closure means suitably substantially seals said elongated body when engaged therewith to prevent escape of said foodstuff therefrom and/or to prevent water entering said elongated body.

Preferably, sufficient of said foodstuff is placed into said container means such that said foodstuff, when cooked, adopts a shape substantially defined by the internal surfaces of said elongated body and said closure means.

More preferably, said container means includes a pair of said closure means each adapted to be removably engaged with opposite ends of said elongated body.

In use, preferably, for receiving said foodstuff, one of said closure means is detached from said elongated body and, for removal of cooked foodstuff, both said closure means are suitably detached from said elongated body to enable the cooked foodstuff to be removed longitudinally in one length from said elongated body.

In an embodiment of the present invention, said elongated body further includes a substantially tubular body, removably held, preferably concentrically, within said elongated body. In this embodiment, the present invention provides a method of cooking a foodstuff with a hollow core to which can be added second victuals, which usually differ from said foodstuff.

In another embodiment of the present invention, said method further includes the step of rotating said container means about its longitudinal axis during exposure to said source of heat, thus assisting in the even cooking of said foodstuff within said container means. In this embodiment, and when said foodstuff is an egg(s), said step of rotating said container means causes the egg white to locate radially outwardly of the egg yolk, the latter locating centrally within said container means.

If desired, suitable additives may be incorporated into said foodstuff prior to cooking. Said additives may include, for example, a food colouring.

In a second aspect of the present invention, there is provided an apparatus for use in a method of cooking foodstuff as hereinbefore described said apparatus including:
a container means, said container means having a hollow body to hold said foodstuff; and
at least one closure means at one end of said hollow body for closing said hollow body, said closure means being removable to permit said foodstuff to be placed in said hollow body prior to cooking and removed from said hollow body after said foodstuff has been cooked:
wherein said container means is adapted to be exposed to a source of heat to cook said foodstuff therein.

Preferably, said container means is adapted to be placed into boiling water or water to be boiled.

Preferably, said hollow body is a hollow elongated body.

Preferably, said container means includes a pair of said closure means adapted to be removably engaged with, and at opposite ends of said elongated body. Said closure means when engaged with said elongated body preferably substantially seals said elongated body to prevent escape of said foodstuff therefrom or to prevent water entering said elongated body.

Preferably, said elongated body and said closure means are adapted such that, after said foodstuff has been cooked in said apparatus, the resultant cooked foodstuff has adopted a shape substantially defined by the internal surfaces of said elongated body and said closure means.

The cross-section of said elongated body may be of any shape as determined by the desired cross-sectional configuration to be produced in said foodstuff once cooked. For example, said elongated body may be of circular cross-section and thus of cylindrical form. Alternatively, said elongated body may be of a cross-sectional form such as square, rectangular, triangular, star shaped, letters, numerals or symbols.

In an embodiment of the present invention, said elongated body further includes a substantially tubular body, removably held, preferably concentrically, within said elongated body. Once again, the cross-section of said tubular body may be of any shape determined by the cross-sectional configuration desired for the resultant hollow core in the cooked foodstuff to which a second victuals is to be added.

In an embodiment of the apparatus of the present invention, said apparatus, comprises a single hollow body having removable closure means at each end.

1-30. (canceled)

31. A method of cooking foodstuff, said method including the steps of:
providing a container means, said container means including a hollow body and at least one removable closure means for said hollow body, said container means being adapted to be placed into boiling water or water to be boiled, said water providing a source of heat,
placing sufficient said foodstuff into said container means such that said foodstuff, when cooked, adopts a shape substantially defined by the internal surfaces of said container means,
closing said container means;
exposing said container means to said source of heat for a period of time sufficient to cook said foodstuff in said container means; and
removing thus cooked said foodstuff from said container means.

32. A method as defined in claim 31 wherein said hollow body is a hollow elongated body and said at least one removable closure means is at one end thereof and wherein said method includes the step of removing said closure means to allow the placement of said foodstuff into said elongated body and thereafter re-attaching said closure means to said elongated body prior to exposing said container means to said source of heat.

33. A method as defined in claim 32 wherein said closure means substantially seals said elongated body when engaged therewith to prevent escape of said foodstuff therefrom and/or to prevent water entering said elongated body.

34. A method as defined in claim 32 wherein said container means includes a pair of said closure means each adapted to be removably engaged with opposite ends of said elongated body.

35. A method as defined in claim 32 wherein said elongated body further includes a substantially tubular body, removably held, within said elongated body.

36. A method as defined in claim 35 wherein said tubular body is held concentrically within said elongated body.

37. A method as defined in claim 31 which further includes the step of rotating said container means about its longitudinal axis during exposure to said source of heat.

38. A method as defined in claim 31 which further includes the step of incorporating one or more suitable additives into said foodstuff prior to cooking of said foodstuff.

39. An apparatus for use in a method of cooking foodstuff, said apparatus including:
container means, said container means having a hollow body adapted to hold sufficient said foodstuff such that said foodstuff, when cooked, adopts a shape substantially defined by the internal surfaces of said container means, and
at least one closure means at one end of said hollow body for closing said hollow body, said closure means being removable to permit said foodstuff to be placed in said hollow body prior to cooking and removed from said hollow body after said foodstuff has been cooked;
wherein said container means is adapted to be placed into boiling water or water to be boiled, said water providing a source of heat to cook said foodstuff therein.

40. An apparatus as defined in claim 39 wherein said hollow body is a hollow elongated body.

41. An apparatus as defined in claim 39 wherein said container means includes a pair of said closure means adapted to be removably engaged with, and at opposite ends of, said hollow body.

42. An apparatus as defined in claim 41 wherein said closure means substantially seals said hollow body when engaged therewith to prevent escape of said foodstuff therefrom and/or to prevent water entering said hollow body.

43. An apparatus as defined in claim 39 wherein said hollow body further includes a substantially tubular body, removably held, within said hollow body.

44. An apparatus as defined in claim 43 wherein said tubular body is held concentrically within said hollow body.

45. An apparatus as defined in claim 42 wherein said apparatus comprises a single hollow body having removable closure means at each end, said closure means at one end being mounted to or formed with a base to enable said hollow body to be supported in an upright attitude by said base seating on a supporting surface during the cooking process.

46. An apparatus as defined in claim 45 wherein said base is of a plate-like configuration and includes a plurality of supporting legs.

47. An apparatus as defined in claim 45 wherein said supporting surface is part of a utensil used to retain said water that provides said source of heat to cook said foodstuff.

48. An apparatus as defined in claim 39 wherein said apparatus comprises one or more of said container means, each said container means being connectable to, so as to extend from, a support member.

49. An apparatus as defined in claim 48 wherein each said container means is adapted to extend generally vertically downwardly from said support member to be submerged in said water providing said source of heat.

50. An apparatus as defined in claim 48 wherein one of said closure means of said container means is attached to or is incorporated into the underside of said support member.

51. An apparatus as defined in claim 48 wherein said support member supports a plurality of said container means.

52. An apparatus as defined in claim 48 wherein said support member includes one or more handles to facilitate manipulation of said apparatus.

53. An apparatus as defined in claim 39 wherein said apparatus includes means for supporting said container means for rotation about its longitudinal axis such that said container means may be rotated about said axis when said container means is subject to said source of heat.

54. An apparatus as defined in claim 53 wherein said source of heat is boiling water and wherein said container means includes one or more vanes or fins on its periphery, said vanes or fins being exposed to said boiling water so as to cause said container means to rotate.

55. An apparatus as defined in claim 54 wherein said container means is supported by a support frame on a baffle-like member which is configured to trap and direct said boiling water towards said fins on said container means.

56. An apparatus as defined in claim 55 wherein said baffle-like member includes a plurality of apertures for directing said water towards said fins.
